(19) United States
(12) Patent Application Publication
(10) Pub. No.: US 2026/0036531 A1
(43) Pub. Date: Feb. 5, 2026

(54) METHOD FOR DETERMINING A DEFORMATION FIELD OF AT LEAST ONE LAYER OF PAINT APPLIED TO A SUPPORT DURING CROSSLINKING OF THE LAYER OR THE LAYERS OF PAINT

(71) Applicant: AIRBUS (S.A.S.), Blagnac (FR)

(72) Inventors: Caroline PETIOT, BLAGNAC CEDEX (FR); Jonas BURTH, BLAGNAC CEDEX (FR); Saber CHELAGHMA, BLAGNAC CEDEX (FR); Walid TEZEGHDANTI, BLAGNAC CEDEX (FR)

(21) Appl. No.: 19/284,326

(22) Filed: Jul. 29, 2025

(30) Foreign Application Priority Data
Jul. 30, 2024 (FR) 2408417

(51) Int. Cl. G01N 23/046

(52) U.S. Cl. CPC G01N 23/046; G01N 2223/1016; G01N 2223/309; G01N 2223/3103; G01N 2223/3106; G01N 2223/419; G01N 2223/61; G01N 2223/615; G01N 2223/634

(57) ABSTRACT

A method for determining a deformation field of at least one layer of paint applied to a support during crosslinking of the layer or the layers of paint is disclosed. The method includes a step (E1) of provision of a sample, a step (E2) of 3D tomographic measurement of the sample and a set of successive steps(S) repeated iteratively comprising a step (E3) of dynamic mechanical analysis of the sample subjected to at least one temperature cycle (C), a step (E4) of 3D tomographic measurement of the sample, a step (E5) of determining a deformation field of each layer of paint of the sample.

### CROSS REFERENCE TO RELATED APPLICATION

This application claims priority to French Application Number FR 2408417, filed Jul. 30, 2024, the entire contents of which is hereby incorporated by reference.

### BACKGROUND

The present disclosure relates to a method for determining the deformation field of at least one layer of paint applied to a support during crosslinking of the one or more layers of paint.

A fuselage or, more generally, a structure of an aircraft, such as a wing, a tail assembly, etc. may comprise various structural layers. These structural layers may be made of metal or, more recently, a composite, for example based on carbon fibres.

Whether the fuselage is made of metal or composite, it is painted to give it a certain visual appearance, as well as in order to provide protection against external aggression. Composite fuselages and more generally the main composite structures of aircraft comprise a stack of plies of composite based on carbon fibres. Once the composite fuselage or the composite structure has been manufactured, it is necessary to paint it in order to display the colours of the airline who owns the aircraft and to protect it against external aggression. To this end, various layers of materials and paint are deposited on the last ply.

In general, a first layer which corresponds to a lightning strike protection layer may be applied to the last ply of the fuselage or of the structure. This lightning strike protection layer comprises a sheet of anti-lightning copper which is embedded in a polymer film including glass fibres to facilitate handling and the application of the sheet of copper.

To this lightning strike protection layer, a basic primer layer and an external primer layer may be applied. These primer layers comprise ceramic pigments to obtain a white colour on which the logo of the airline may be applied.

An intermediate coating, which promotes stripping of the layers in the case where it is necessary to repaint the fuselage or the structure, may be applied to these primer layers.

Lastly, a base coating, followed by a transparent coating which add gloss to the fuselage or to the structure, may be applied to the intermediate coating.

These various layers are applied to the last ply of the fuselage or of the structure after curing in an autoclave and prior application before polymerization of the lightning strike protection layer. Note that the polymerization of the composite forming the fuselage or the structure equipped with the lightning strike protection layer may optionally exhibit a state of post-curing residual stress owing to dissymmetry arising in the construction of the composite forming the fuselage or the structure by the addition of the lightning strike protection layer and depending on the cooling cycle implemented following curing.

The application of the layers after curing is carried out by spraying at ambient temperature. It is therefore necessary to wait a certain length of time, of around several hours, between the application of each layer in order to allow drying by polymerization or crosslinking of each layer. Therefore, it takes around three weeks for the total cycle time for painting an aircraft.

Other ways of applying the various layers may be envisaged, such as layers applied by moulding and compression.

The aircraft is then delivered to the airline which operates it. The aircraft is then subjected to temperature cycles ranging on average generally from −55° C. in flight to 85° C. on the ground. However, it has sometimes been found that, when the aircraft is delivered to the airline, the polymerization or the crosslinking of the various layers is not complete. Each layer continues to polymerize or crosslink independently of the others. Their respective properties continue to evolve since the molecular chains are not fixed. The layers are therefore not in a thermostable configuration when the aircraft is delivered.

Consequently, upon aging of the layers, defects may appear on the surface of the fuselage or the structure because they are more sensitive to thermal stress, to ultraviolet radiation, to water or to oxidation, which exacerbates the aging of the layers. Moreover, the release of volatiles present in the layers during the process of crosslinking or polymerization increases the stresses internal to the layers, which can give rise to cracking, blistering, etc. in the layers.

It can thus be important to understand the phenomena at play during the crosslinking or the polymerization of the layers and in particular to detect how the layers are evolving during their crosslinking or polymerization. Understanding these phenomena makes it possible to find ways of improving the method of application of the layers and/or improving the chemical formula of the layers.

### SUMMARY

The present disclosure aims to provide a method with the intention of understanding the phenomena at play during the crosslinking or the polymerization of the layers and in particular detecting how the layers evolve during crosslinking or polymerization.

To this end, the disclosure relates to a method for determining a deformation field of at least one layer of paint applied to a support during crosslinking of the one or more layers of paint.

According to an exemplary embodiment, the determination method comprises the following steps:
a step of provision of a sample including the support and the one or more layers of paint applied to the support;
a first step of three-dimensional tomographic measurement of the sample so as to obtain a first three-dimensional image of the sample;
a set of successive steps repeated iteratively until the difference between a loss modulus for a current iteration and a loss modulus obtained for a previous iteration is less than or equal to a predetermined threshold:
a step of dynamic mechanical analysis of the sample subjected to at least one temperature cycle evolving between a predetermined minimum temperature and a predetermined maximum temperature, so as to obtain a loss modulus of the sample,
a second step of three-dimensional tomographic measurement of the sample so as to obtain a second three-dimensional image of the sample,
a step of determining a deformation field of each layer of paint of the sample on the basis of the first image and the second image, the first image of the current iteration corresponding to the second image of the previous iteration.

Thus, by virtue of the determination of the loss modulus, it is possible to follow the evolution of the crosslinking of the one or more layers of paint while observing the deformations of the one or more layers of paint with the aid of tomographic measurements. The number of tests is therefore kept to the minimum necessary.

Furthermore, the step of determining a deformation field comprises:
a first sub-step of determining a displacement field between the first image and the second image by digital volume correlation,
a second sub-step of determining a deformation field of the one or more layers of paint on the basis of the displacement field.

Advantageously, the first determination sub-step comprises calculating the argument of the minimum of a residual correlation field from the following relation:

$${ϕ}_{c}^{2} = {\int }_{ROI} {[ g ( ( x ) + u ( x ) ) - f ( x ) ]}^{2} d x ,$$

in which:
ROI corresponds to a region of interest in which an analysis of the displacement field is performed,
x corresponds to the coordinates of any voxel of the region of interest, f(x) corresponds to a grey level volume in the region of interest of the reference image,
g(x) corresponds to a grey level volume in the region of interest of the deformed image,
u(x) corresponds to the displacement field to be determined,
ϕ_{c} corresponds to the residual correlation field.

Furthermore, the second determination sub-step comprises calculating the derivative of the displacement field so as to obtain the deformation field.

Moreover, the first step of tomographic measurement and the second step of tomographic measurement are carried out using an X-ray microtomography measurement device.

Furthermore, the step of dynamic mechanical analysis comprises the implementation of mechanical limit conditions on the sample at a predetermined frequency during which the sample is subjected to at least one temperature cycle.

For example, the mechanical limit conditions on the sample correspond to bending at three points of the sample at a frequency of 1 Hz.

Moreover, the temperature cycle corresponds to:
a gradual evolution in temperature from an ambient temperature to the predetermined maximum temperature, then
a first pause at the predetermined maximum temperature for a predetermined duration, then
a gradual evolution in temperature from the predetermined maximum temperature to the predetermined minimum temperature, then
a second pause at the predetermined minimum temperature for a predetermined duration until the end of the temperature cycle.

Furthermore, the method comprises a step of analysis of an evolution of the deformation field of the one or more layers of paint on the basis of the one or more deformation fields determined for each iteration of implementation of the set of successive steps, the analysis step being carried out after the last iteration of the set of successive steps S.

### BRIEF DESCRIPTION OF THE DRAWINGS

The attached figures will clearly show how embodiments can be implemented. In these figures, identical references designate similar elements.

FIG. 1 schematically depicts the determination method.

FIG. 2 depicts a cross section through an example of a sample.

FIG. 3 depicts a curve showing the evolution over time of temperature during a temperature cycle.

FIG. 4 depicts a curve showing the evolution over time of the loss modulus.

FIG. 5 depicts, on the left, a dynamic mechanical analysis machine including a sample and, on the right, a sample subjected to a stress at three points in the dynamic mechanical analysis machine.

### DETAILED DESCRIPTION

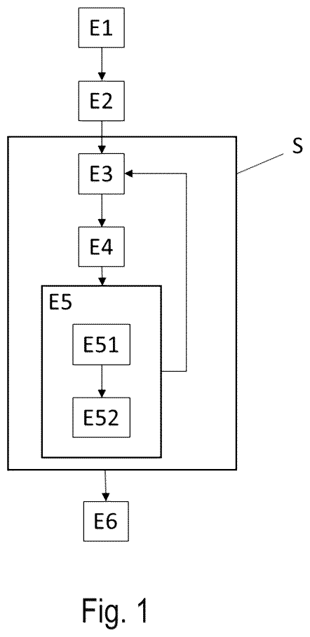

The method for determining a deformation field (hereinafter referred to as the “determination method”) is shown schematically in FIG. 1.

The determination method corresponds to a method for determining the deformation field of at least one layer of paint 3 applied to a support 2 during crosslinking of the one or more layers of paint 3. This determination method also makes it possible to observe the evolution of the deformation field.

The determination method comprises a step E1 of provision of a sample 1 including the support 2 and the one or more layers of paint 3 applied to the support 2. During this provision step E1, a sample 1 representative of the one or more layers of paint 3 and the support 2 of a part of a structure is manufactured. The part of a structure may be a fuselage of an aircraft, or a hull of a vessel, or any other structure including at least one layer of paint applied to a support.

In one mode of production of the sample 1, the support 2 corresponds to a composite support comprising three plies including carbon fibres that are substantially parallel to one another so as to be able to have a gloss primer layer and/or a transparent layer.

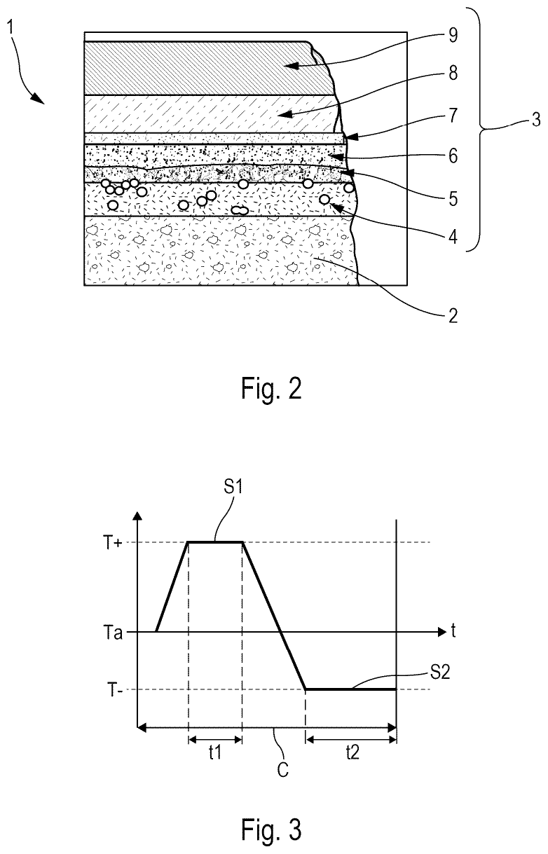

FIG. 2 depicts an example of a sample 1. In this example, the sample 1 provided comprises several layers 3 which are applied to a support 2. The sample 1 according to this example comprises a first layer 4 which corresponds to a lightning strike protection layer. This lightning strike protection layer may comprise a sheet of anti-lightning copper which is embedded in a polymer film including glass fibres to facilitate handling and the application of the sheet of copper.

The sample 1, according to the example, comprises a second layer 5 which corresponds to a basic primer layer and a third layer 6 which corresponds to an external primer layer. The second layer 5 and the third layer 6 are applied to the first layer 4. They comprise ceramic pigments so as to obtain a white colour on which the logo of the airline may be applied.

The sample 1 according to the example comprises a fourth layer 7 applied to the third layer 6. The fourth layer 7 corresponds to an intermediate coating which promotes stripping of the layers in the case where it is necessary to repaint the fuselage or the structure.

Lastly, the sample 1 according to the example comprises a fifth layer 8 and a sixth layer 9 which are applied to the fourth layer 7. The fifth layer 8 and the sixth layer 9 correspond to a base coating and a transparent coating, respectively. The fifth layer 8 and the sixth layer 9 add gloss to the fuselage or to the structure.

The determination method moreover comprises a first step E2 of three-dimensional tomographic measurement of the sample 1 so as to obtain a first three-dimensional image of the sample 1. The first three-dimensional image of the sample 1 obtained in the first step E2 of tomographic measurement may correspond to a three-dimensional greyscale image. The difference between grey levels corresponds to the difference in atomic density of the materials and hence to the different materials of the layers of paint 3.

The first image obtained in the first step E2 of tomographic measurement may be stored in a memory.

The first step E2 of tomographic measurement may be carried out using an X-ray microtomography measurement device. This measurement technique is non-destructive. It makes it possible to digitize in grayscale voxels the microstructure of a material via a three-dimensional image. The first step E2 of tomographic measurement makes it possible to obtain the first three-dimensional image which corresponds to a reference digitization of the sample 1. Thus, in this first step E2, the first image corresponds to a reference image in which crosslinking has just begun.

The X-ray microtomography measurement device may correspond to an X-ray synchrotron at the European Synchrotron Radiation Facility (ESRF) in Grenoble or to an X-ray tomography machine in a conventional laboratory.

Furthermore, the determination method comprises a set of successive steps S. This set of successive steps S is repeated iteratively until a difference (in absolute value) between, on the one hand, a loss modulus of the sample 1 for a current iteration and, on the other hand, a loss modulus of the sample 1 obtained for a previous iteration is less than or equal to a predetermined threshold. The predetermined threshold is determined to indicate that the evolution of the loss modulus tends towards a plateau. To be specific, the smaller the difference between two loss moduli of two successive iterations, the more the evolution of the loss modulus tends towards a plateau. For example, the predetermined threshold may be substantially equal to zero or a value close to zero, which means that the loss modulus is no longer substantially evolving.

Each iteration corresponds to at least one test carried out on the sample 1. The set of successive steps S comprises a step E3 of dynamic mechanical analysis of the sample 1, a second step E4 of tomographic measurement and a step E5 of determining a deformation field of each layer of paint 3.

The step E3 of dynamic mechanical analysis (DMA) may be carried out with the aid of a dynamic mechanical analysis machine 10 (drawing(A) in FIG. 5). Dynamic mechanical analysis is a technique making it possible to study and to characterize the mechanical properties of viscoelastic materials, such as polymers, under dynamic and thermal stress. Dynamic mechanical analysis makes it possible to determine a complex modulus E* in the form: E*=E′+iE″, in which E′ corresponds to the conservation modulus characteristic of the elastic response of the material analysed and E″ corresponds to the loss modulus characteristic of the viscous response of the material analysed. The loss modulus is usually expressed in Pascal. The loss modulus may be determined by a processor from measurements obtained by the dynamic mechanical analysis machine 10.

The analysis machine may correspond to the DMA Q800 from TA Instruments or to the DMA+1000 from Metravib.

In step E3 of dynamic mechanical analysis, the sample 1 is subjected to at least one temperature cycle C evolving between a predetermined minimum temperature T− and a predetermined maximum temperature T+ so as to obtain the loss modulus of the sample 1. Without this being limiting, the predetermined maximum temperature T+ may lie within a range between 60° C. and 70° C. and the predetermined minimum temperature may lie within a range between −40° C. and −30° C. The temperature cycles may be implemented at a predetermined frequency.

FIG. 3 depicts an example of a temperature cycle C. In this example, the temperature cycle C corresponds to:
a gradual evolution in temperature from an ambient temperature Ta (in which the sample 1 is in the initial state) to the predetermined maximum temperature T+, then
a first pause S1 at the predetermined maximum temperature T+ for a predetermined duration t1, then
a gradual evolution in temperature from the predetermined maximum temperature T+ to the predetermined minimum temperature T−, then
a second pause S2 at the predetermined minimum temperature T− for a predetermined duration t2 until the end of the temperature cycle C.

The step E3 of dynamic mechanical analysis may comprise the implementation of mechanical limit conditions on the sample 1 at a predetermined frequency during which the sample 1 is subjected to at least one temperature cycle C.

The mechanical limit conditions on the sample 1 may correspond to bending at three points P1, P2, P3 of the sample 1 at a frequency of 1 Hz, as shown in drawing(B) in FIG. 5. The bending at three points corresponds to the application of a predetermined force F1 at the point P1 and to the application of a force F2 at the point P2 and of a force F3 at the point P3 on either side of the point P1. The forces F1, F2 and F3 are colinear. The force F1 has a direction opposite to the direction of the forces F2 and F3.

The set of successive steps S further comprises a second step E4 of three-dimensional tomographic measurement of the sample 1 so as to obtain a second three-dimensional image of the sample 1. The second step E2 of tomographic measurement makes it possible to obtain the second three-dimensional image which corresponds to a digitization of the sample 1 after the step E3 of dynamic mechanical analysis. The second image is therefore substantially different to the first image. The second image obtained in the second step E4 of tomographic measurement may be stored in a memory.

The second step E4 of tomographic measurement may also be carried out with the aid of an X-ray microtomography measurement device. The X-ray microtomography measurement device may also correspond to an X-ray synchrotron at the European Synchrotron Radiation Facility (ESRF) in Grenoble or to an X-ray tomography machine in a conventional laboratory. The set of successive steps S further comprises a step E5 of determining a deformation field of each layer of paint 3 of the sample 1 on the basis of the first image and the second image. The determination step E5 may be carried out using a processor.

The first image of the current iteration of implementation of the suite of successive steps S corresponds to the second image of the previous iteration of implementation of the suite of successive steps S.

The deformation field for each iteration may be stored in a memory.

The step E5 of determining a deformation field may comprise a first sub-step E51 of determining a displacement field between the first image and the second image by digital volume correlation. The determination step E5 may also comprise a second sub-step E52 of determining a deformation field of the one or more layers of paint on the basis of the displacement field.

The digitization of the sample 1 makes it possible to obtain grey levels attributed to voxels. Thus, by comparing a reference volume f(x) of the first image and a reference volume g(x) by volume correlation, it is possible to determine a displacement field u(x) between the two volumes. The principle of digital volume correlation is based on the hypothesis of conservation of the grey levels. This displacement of volumes makes it possible to obtain a deformation field of the different layers of paint 3 of the sample 1.

Advantageously, the first determination sub-step E51 may comprise calculating the argument of the minimum of a residual correlation field on the basis of the following relation:

$${ϕ}_{c}^{2} = {\int }_{ROI} {[ g ( ( x ) + u ( x ) ) - f ( x ) ]}^{2} d x ,$$

in which:
ROI corresponds to a region of interest in which an analysis of the displacement field is performed,
x corresponds to the coordinates of any voxel of the region of interest,
f(x) corresponds to a grey level volume in the region of interest of the reference image,
g(x) corresponds to a grey level volume in the region of interest of the deformed image,
u(x) corresponds to the displacement field to be determined,
ϕ_{c} corresponds to the residual correlation field.

The second determination sub-step E52 may comprise calculating the derivative of the displacement field so as to obtain the deformation field.

As stated above, the set of successive steps S is repeated iteratively until a difference between, on the one hand, a loss modulus of the sample 1 for a current iteration and, on the other hand, a loss modulus of the sample 1 obtained for a previous iteration is less than or equal to a predetermined threshold. To be specific, the number of iterations is determined as a function of the loss modulus that is representative of the overall viscosity of the layers of paint 3 of the sample 1 for which each layer of paint 3 contributes. When a material reaches the end of crosslinking, the loss modulus evolves very little. It is therefore possible to monitor the evolution of the behaviour of the sample 1 only during the phase of evolution of the loss modulus. It is in fact during this period of time that the phenomena that give rise to defects appear.

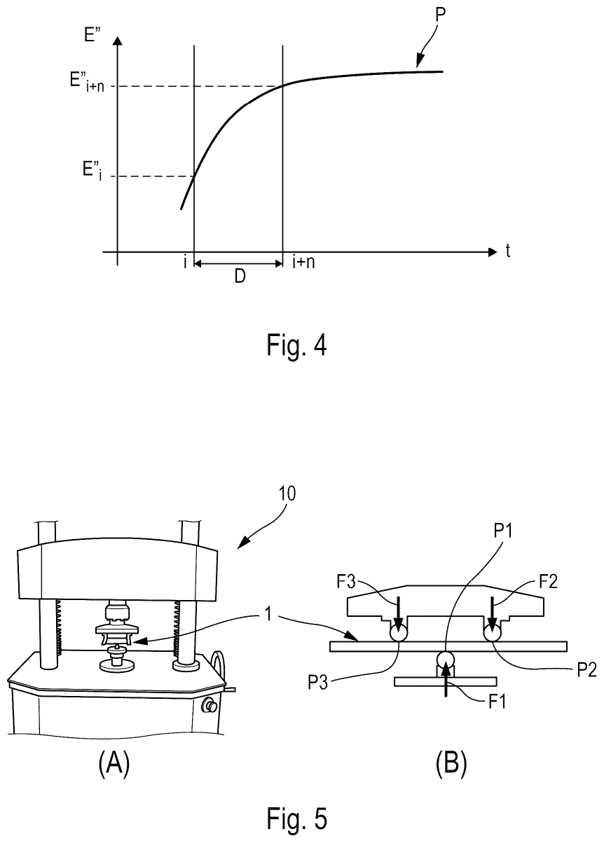

FIG. 4 depicts an example of a curve showing the evolution of the loss modulus as a function of time. During a time D between the time i and the time i+n, the loss modulus evolves, increasing from E″ᵢ to E″ᵢ₊₁, and reaches a plateau in which the loss modulus evolves very little. Thus, by determining the difference between, on the one hand, a loss modulus of the sample 1 for a current iteration and, on the other hand, a loss modulus of the sample 1 obtained for a previous iteration, it is possible to limit the number of iterations as a function of the evolution of the loss modulus.

After the last iteration of the set of successive steps S, the determination method may comprise a step E6 of analysis of an evolution of the deformation field of the one or more layers of paint 3 on the basis of the one or more deformation fields determined in step E5 for each iteration of implementation of the set of successive steps S. Step E6 of analysis may be carried out by a processor or by an operator on the basis of the one or more deformation fields that may be stored in the memory.

The fact that it is possible to limit the number of iterations with the aid of the loss modulus makes it possible to meet an industrial constraint whereby the number of tests carried out must be compatible with the time constraints and financial constraints of manufacture of an aircraft. Thus, it is possible to carry out a series of temperature cycles in the dynamic mechanical analysis machine 10 and to construct the evolution of the loss modulus (FIG. 4). This makes it possible to determine the range in which the phase of evolution of the loss modulus is, and hence to determine the number of temperature cycles strictly necessary. The tests carried out according to the method make it possible to obtain information much more quickly than tests carried out under actual conditions.

Thus, in only two or three iterations, it is possible to reconstruct a profile of the different layers of paint 3 of the sample and to analyse which of those layers of paint 3 is or are causing the defect. To be specific, by virtue of the images obtained, the levels of deformation of the layers of the sample 1 are detected and it is possible to determine when a deformation becomes too great: in this case, the level of stress generated by this deformation may result in cracking. The analysis of the evolution of the deformation field may help to determine the one or more layers of paint 3 responsible for causing a defect appearing by crosslinking. For example, a single layer of paint may be the cause of a defect appearing in another layer of paint. Thus, the analysis of the evolution of the deformation field makes it possible to determine the layer of paint which is causing the defect.

Following this determination method, it is thus possible to identify the one or more layers of paint 3 responsible for the defect and hence to:
work on the industrial process of deposition of the layers in such a way as to eliminate or limit deformations, by better management of the crosslinking of the layers of paint 3: recommendation of the drying time, drying accelerator, and/or
change the chemical formula of the one or more layers of paint 3 so that its behaviour during crosslinking does not give rise to deformations that are too great, and/or
use layers of paint 3 that are already at an advanced stage of crosslinking at the time of deposition, and/or
use a catalyst to accelerate crosslinking or an external acceleration means such as UV lamps for example.

This reduces manufacturing times, by targeting the one or more layers requiring action. Moreover, this method is easily applicable to new materials and makes it possible to obtain, right from the first aircraft, a reliable result.

While at least one exemplary embodiment is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for determining a deformation field of at least one layer of paint applied to a support during crosslinking of the one or more layers of paint, comprising:
a step (E1) of provision of a sample including the support and the one or more layers of paint applied to the support;
a first step (E2) of three-dimensional tomographic measurement of the sample so as to obtain a first three-dimensional image of the sample;
a set of successive steps(S) repeated iteratively until the difference between a loss modulus for a current iteration and a loss modulus obtained for a previous iteration is less than or equal to a predetermined threshold:
a step (E3) of dynamic mechanical analysis of the sample subjected to at least one temperature cycle (C) evolving between a predetermined minimum temperature (T−) and a predetermined maximum temperature (T+), so as to obtain a loss modulus of the sample,
a second step (E4) of three-dimensional tomographic measurement of the sample so as to obtain a second three-dimensional image of the sample,
a step (E5) of determining a deformation field of each layer of paint of the sample on the basis of the first image and the second image, the first image of the current iteration corresponding to the second image of the previous iteration.

2. The method according to claim 1, wherein the step (E5) of determining a deformation field comprises:
a first sub-step (E51) of determining a displacement field between the first image and the second image by digital volume correlation,
a second sub-step (E52) of determining a deformation field of the one or more layers of paint on the basis of the displacement field.

3. The method according to claim 1, wherein the first determination sub-step (E51) comprises calculating the argument of the minimum of a residual correlation field from the following relation:
$${ϕ}_{c}^{2} = {\int }_{ROI} {[ g ( ( x ) + u ( x ) ) - f ( x ) ]}^{2} d x ,$$
in which:
ROI corresponds to a region of interest in which an analysis of the displacement field is performed,
x corresponds to the coordinates of any voxel of the region of interest,
f(x) corresponds to a grey level volume in the region of interest of the reference image,
g(x) corresponds to a grey level volume in the region of interest of the deformed image,
u(x) corresponds to the displacement field to be determined,
ϕ_{c} corresponds to the residual correlation field.

4. The method according to claim 2, wherein the second determination sub-step (E52) comprises calculating the derivative of the displacement field so as to obtain the deformation field.

5. The method according to claim 1, wherein the first step (E2) of tomographic measurement and the second step (E4) of tomographic measurement are carried out using an X-ray microtomography measurement device.

6. The method according to claim 1, wherein the step (E3) of dynamic mechanical analysis comprises the implementation of mechanical limit conditions on the sample at a predetermined frequency during which the sample is subjected to at least one temperature cycle (C).

7. The method according to claim 6, wherein the mechanical limit conditions on the sample correspond to bending at three points (P1, P2, P3) of the sample at a frequency of 1 Hz.

8. The method according to claim 1, wherein the temperature cycle (C) corresponds to:
a gradual evolution in temperature from an ambient temperature (Ta) to the predetermined maximum temperature (T+), then
a first pause (S1) at the predetermined maximum temperature (T+) for a predetermined duration (t1), then
a gradual evolution in temperature from the predetermined maximum temperature (T+) to the predetermined minimum temperature (T−), then
a second pause (S2) at the predetermined minimum temperature (T−) for a predetermined duration (t2) until the end of the temperature cycle (C).

9. The method according to claim 1, further comprising a step (E6) of analysis of an evolution of the deformation field of the one or more layers of paint on the basis of the one or more deformation fields determined for each iteration of implementation of the set of successive steps(S), the analysis step (E6) being carried out after the last iteration of the set of successive steps S.
